(19) United States
(12) Patent Application Publication
(10) Pub. No.: US 2017/0050764 A1
(43) Pub. Date: Feb. 23, 2017

(54) Rack for Containers of Fluid

(71) Applicant: Forrest C. Caul, III, Magna, UT (US)

(72) Inventor: Forrest C. Caul, III, Magna, UT (US)

(21) Appl. No.: 15/243,751

(22) Filed: Aug. 22, 2016

Related U.S. Application Data
(60) Provisional application No. 62/208,462, filed on Aug. 21, 2015.

(51) Int. Cl. B65D 25/24; A47B 88/04; F16B 47/00; A47B 81/00

(52) U.S. Cl. CPC B65D 25/24; A47B 81/00; A47B 88/04; F16B 47/00

(57) ABSTRACT

A rack supports a container so as to lift it to an angle and provide biasing of contained liquid towards an opening. The rack may also be automatically or manually operated. In its simplest embodiment, a base and platform, upon which the container is placed, are in a pivoting relationship while at least one support leg lifts the platform in a manner to provide the angled bias. A container stop may also be provided on the platform to aid in supporting the container while in an angled position. A cup ledge may also be provided in those applications where the container may have a dispenser cup (such as with liquid laundry detergent). A drawer may also be provided to turn the rack into a sheltered storage space.

### CROSS-REFERENCES TO RELATED APPLICATIONS

This Application claims priority under 35 USC 119(e)(3) as a non-provisional perfection of prior filed U.S. App. No. 62/208,462, filed Friday, Aug. 21, 2015 and incorporates the same by reference in its entirety.

### FIELD OF THE INVENTION

The present invention relates to the field of storage and more particularly relates to a rack for a container of fluid which biases fluid towards an opening of the container.

### BACKGROUND OF THE INVENTION

Useful fluids are normally stored in some form of container, such as a bottle or jug, which is then easily stored on a surface, such as a shelf. Usually, the liquid is poured from an opening towards the top of the container. Since liquids settle on the bottom of a container, this arrangement naturally keeps the liquid away from the opening. However, for more viscous fluids this is somewhat troublesome as there can be significant delay when such a fluid is desired to be dispensed and the fluid nears empty. The use of valves have allowed a container opening towards the bottom of a container, thus allowing more viscous fluids to be dispensed easier. These valves are usually somewhat removed from the bottom, leaving a layer of liquid between the bottom of the valve and the bottom of the container, thus creating the same issue as before, though somewhat lessened. Tipping a container so that the contained liquid flows towards the opening is common, but container structures are often unstable if tipped off of their storage orientation. It would be useful to have a way of tipping a container so that liquid could flow in a controlled manner towards an opening while also maintaining the stability of the container.

The present invention is a rack for containers of liquids. The rack simply holds the container in its storage orientation and provides a slope that tilts the container towards its opening, in particular a valve opening, so as to accumulate the liquid about the opening for easier dispensing. The rack may be made to tilt according to human intervention or by natural biasing as the container becomes lighter. A lip on the rack facilitates holding the container in its tilted position.

### SUMMARY OF THE INVENTION

In view of the foregoing disadvantages inherent in container construction this invention provides a rack for facilitating the dispensing of liquids from containers. As such, the present invention's general purpose is to provide a new and improved rack that is capable of elevating one end of a container, causing the container to tip towards an opening, while providing a stable support for the container itself. The rack may be manually operated or may automatically raise the container's end as the container becomes lighter through continued dispensing of contained liquid.

To accomplish these objectives, the rack comprises base with an arm hingedly attached at one side. On the side opposite the hinge, a support is provided. The support may be a simple rod or block which may be pivoted into position by a user or it may be a spring loaded or other weight responsive structure to raise the arm as there is less weight on the rack. This rack is best used with valved containers where the valve is located proximate a bottom region of the container. These containers are usually positioned on their sides, with the valve sticking over a rim of whatever shelf or structure supports them.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of one embodiment of a rack according to the present invention, deployed.

FIG. 2 is a perspective view of the rack of FIG. 1, stowed.

FIG. 3 is an alternate exploded view of the rack of FIG. 1.

FIG. 4 is a front elevation of the rack of FIG. 1.

FIG. 5 is a side elevation of the rack of FIG. 1.

FIG. 6 is a bottom plan view of the rack of FIG. 1.

FIG. 7 is a top plan view the rack of FIG. 2.

FIG. 8 is a bottom plan view of the rack of FIG. 2.

FIG. 9 is front elevation of the rack of FIG. 2.

FIG. 10 is a side elevation of the rack of FIG. 2.

FIG. 11 is a side elevation of the rack of FIG. 1, with an illustrative bottle of liquid stored thereon.

### DETAILED DESCRIPTION OF THE PREFERRED EMBODIMENT

With reference now to the drawings, the preferred embodiment of the rack is herein described. It should be noted that the articles “a”, “an”, and “the”, as used in this specification, include plural referents unless the content clearly dictates otherwise.

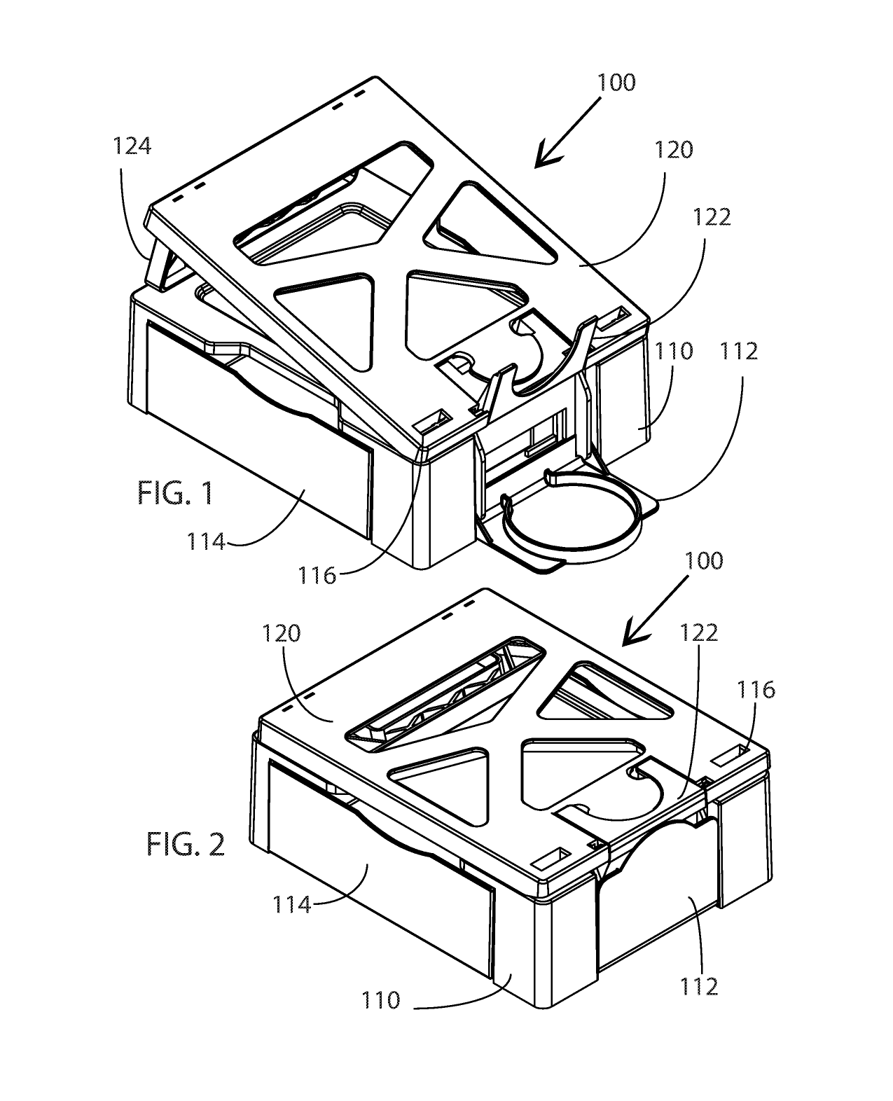

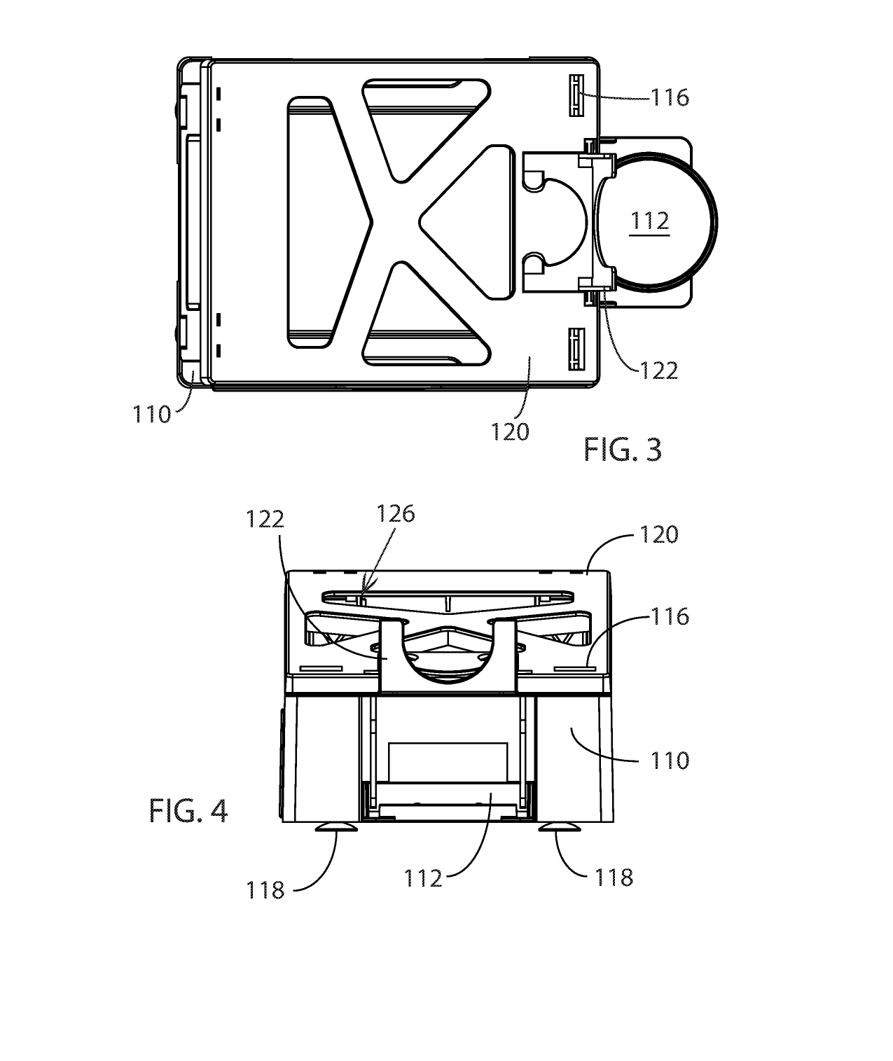

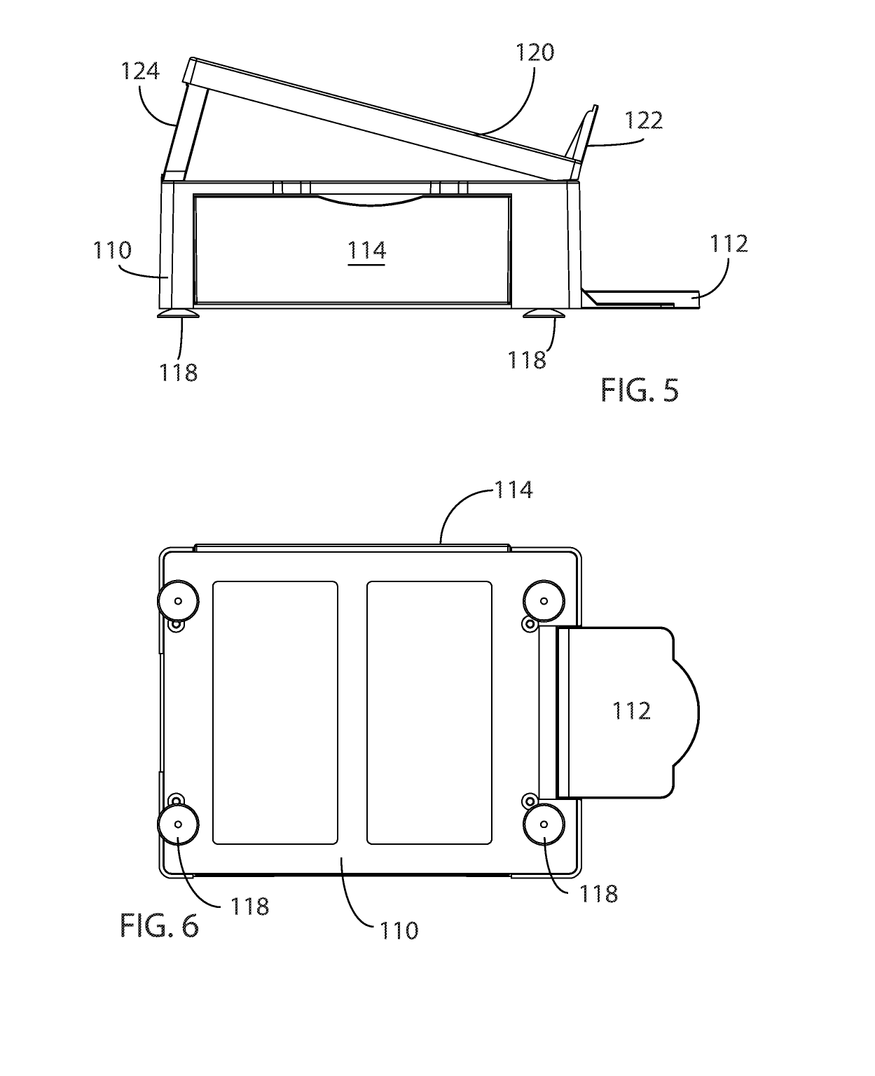

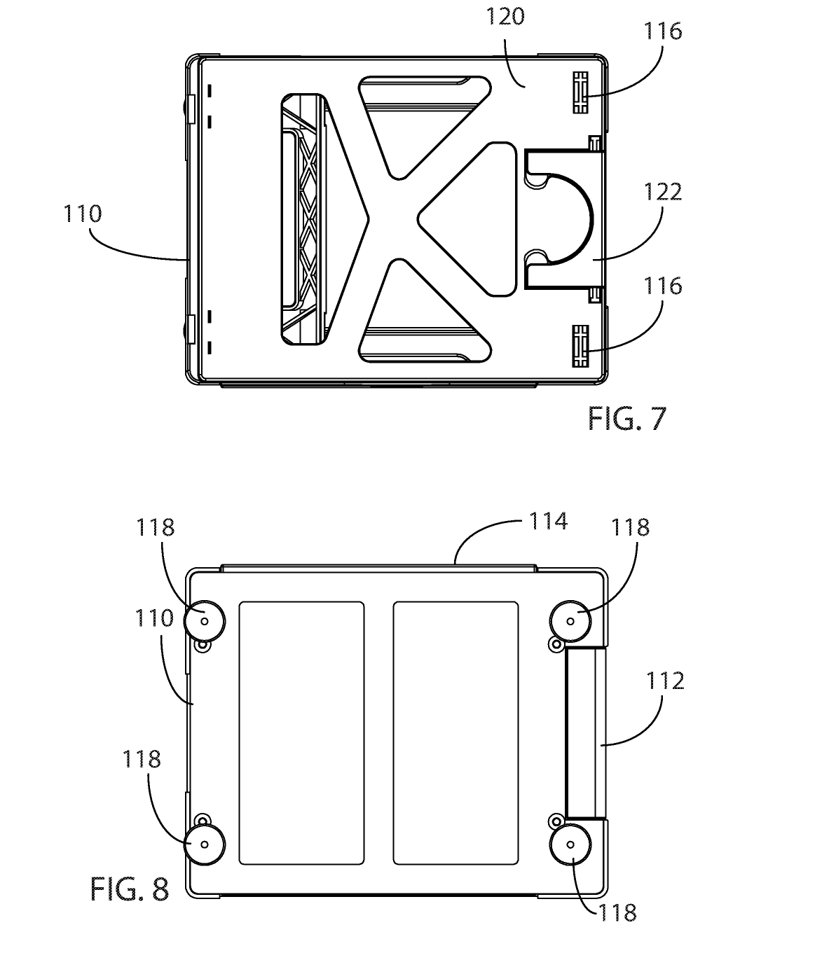

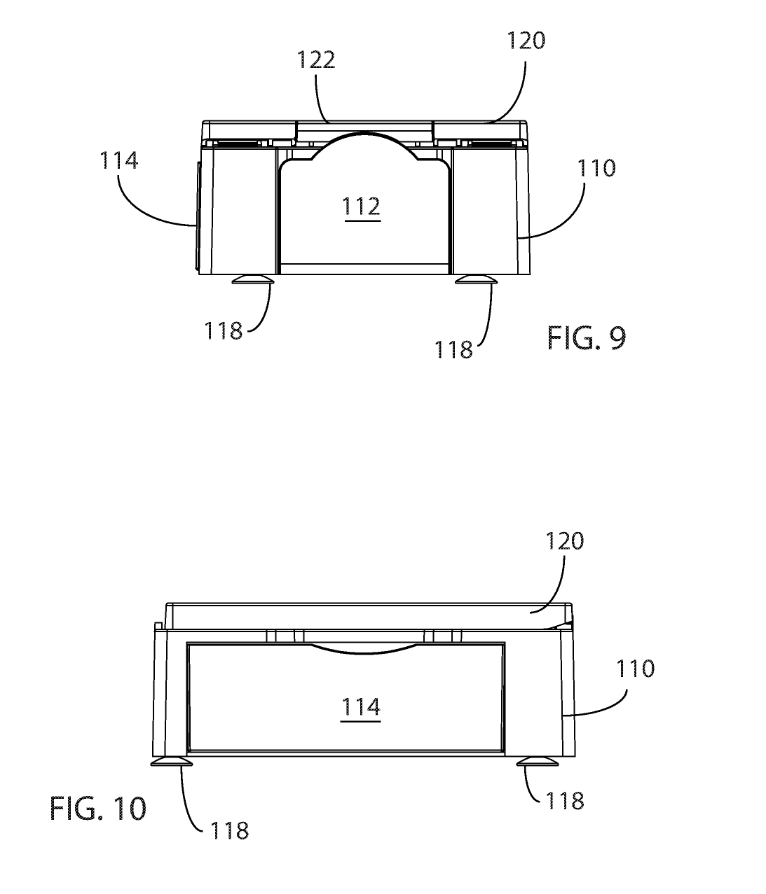

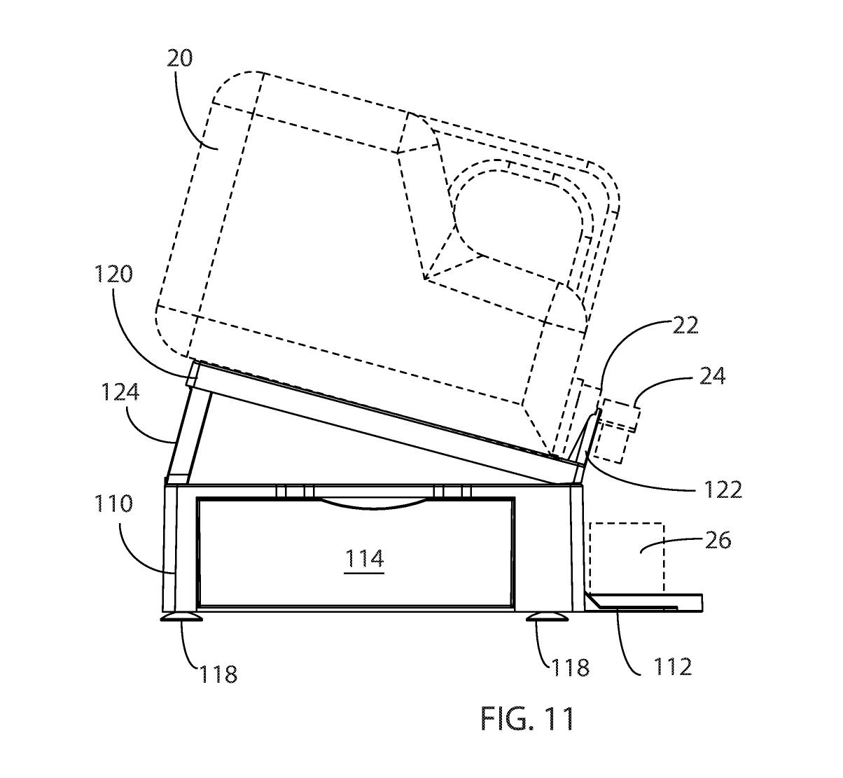

With reference to the FIGS. 1-10, the rack 10 features three main components: a base 110, a platform 120, and legs 124. Base 110 and platform 120 are pivotably joined 116 at one end. Legs 124 may be positioned by the non-pivoted end of the rack 10 so as to support a container 20 (FIG. 11) while the platform 120 is lifting said container at an angle.

Many embodiments of the legs 124 exist, but the preferred embodiment is a set of two legs 124 which fold into either the platform 120 or the base 110 and may be deployed when an angled support of the container 20 is desired. The legs 124 may be a manually operated support or a spring operated one. In one spring-loaded embodiment, as the container becomes less and less full, weight on the legs 124 may lessen, allowing spring force to deploy the legs 124 and raise the platform 120. In another spring-loaded embodiment, as is shown in the Figures, in particular FIG. 4, a torsion spring 126 may bias a leg 124 such that when the platform 120 is lifted, the leg 124 will deploy. In any embodiment, it is generally wise to have a container stop 122 to keep the container 20 from sliding off of the platform 120. The preferred embodiment of container stop 122 is a simple fold up wall which fits around a neck 22 of the container 20, such that a nozzle 24 may protrude over the edge of the rack 10 (FIG. 11). As a fold-out wall, the preferred container stop 122 is easily stowed when the rack 10 is not in use. It is readily understood that other configurations for the container stop are possible, including but not limited to a rim about at least the hinged edge of the platform 120, a removable stop, a block, or any other obstacle readily conceived to arrest motion of the container 20 while being held by the rack 10.

Another optional, though preferred, component of the rack is the addition of a cup ledge 112. This cup ledge 112 may be foldable, like the preferred container stop, or may be static, or even omitted. Its presence provides a convenient location to store a cup 226 which may be used for some contained substances, like laundry detergent (FIG. 11). Providing foldable legs 124, container stop 122 and cup ledge 112 allow the rack 10 to be stowed in a more compact volume, such as is shown in FIGS. 2 and 7-10. Another useful, but optional, feature would be the addition of a drawer 114 which would then allow access and storage in the volume under the base 110. Ideally, the rack 10 is in some way secured to an underlying surface. One way to do so is to provide support feet, such as suction cups 118. Use of suction cups allows the rack may be secured to a smooth and flat surface. Other support feet are possible, including skid resistant rubber feet, hooks, brackets, or any other manner of securement or support.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A rack for containers, the rack comprising:
a. a base;
b. a platform connected to one end of the base by at least one hinge;
c. at least one support at an end of the base opposite the at least one hinge; and
d. a container stop, located proximate the at least one hinge.

2. The rack of claim 1, the at least one support being hingedly connected to the platform in a manner to allow deployment of said at least one support when desired.

3. The rack of claim 1, further comprising a cup ledge, proximate the at least one hinge.

4. The rack of claim 3, the cup ledge being hingedly connected to the base in a manner to allow deployment when its use is desired.

5. The rack of claim 1, further comprising a drawer within the base, providing access to a volume contained within the base.

6. The rack of claim 1, further comprising at least one support feet.

7. The rack of claim 6, the at least one support feet being at least one suction cup.
